(19) United States
(12) Patent Application Publication
(10) Pub. No.: US 2025/0250939 A1
(43) Pub. Date: Aug. 7, 2025

(54) SHAFT DRIVEN MAIN PUMP BYPASS VIA ELECTRIC PUMP

(71) Applicant: Hamilton Sundstrand Corporation, Charlotte, NC (US)

(72) Inventors: Naison E. Mastrocola, Goshen, CT (US); Ryan Prescott Susca, Windsor, CT (US)

(21) Appl. No.: 18/431,227

(22) Filed: Feb. 2, 2024

(51) Int. Cl. F02C 7/22; F02C 7/32

(52) U.S. Cl. CPC F02C 7/22; F02C 7/236; F02C 7/32; F02C 9/32

(57) ABSTRACT

A fuel delivery system for a gas turbine engine includes a fuel source and a main fuel pump configured to deliver a first flow of fuel to a combustor assembly of the gas turbine engine under a first, relatively high fuel demand operating condition of the gas turbine engine. A secondary fuel pump is configured to deliver a second flow of fuel to the combustor assembly under a second, relatively low fuel demand operating condition of the gas turbine engine.

### BACKGROUND

Exemplary embodiments pertain to the art of gas turbine engines, and more particularly to fuel delivery systems of gas turbine engines.

Fuel delivery systems for gas turbine engines utilize a variety of pumps, often driven by a gearbox that extracts power from operation of the gas turbine engine to drive the pumps. A common configuration is a fuel delivery system having dual positive displacement pumps that are both coupled to a fixed input, the speed of which tracks with engine RPM, in particular to the RPM of the engine shaft to which the pumps are connected via the gearbox.

The pump elements are typically sized to meet the requirements of engine start, the condition which places the greatest demand on the fuel delivery system. This excess pump capacity, however, is wasted at other operating conditions, such as cruise operations where demands on the fuel delivery system are lower. Thus, the art would welcome a solution to improve efficiency of the fuel delivery system across operating conditions.

### BRIEF DESCRIPTION

In an exemplary embodiment, a fuel delivery system for a gas turbine engine includes a fuel source and a main fuel pump configured to deliver a first flow of fuel to a combustor assembly of the gas turbine engine under a first, relatively high fuel demand operating condition of the gas turbine engine. A secondary fuel pump is configured to deliver a second flow of fuel to the combustor assembly under a second, relatively low fuel demand operating condition of the gas turbine engine.

Additionally or alternatively, in this or other embodiments the secondary fuel pump is electrically driven.

Additionally or alternatively, in this or other embodiments the first operating condition is takeoff operation of the gas turbine engine.

Additionally or alternatively, in this or other embodiments the second operating condition is cruise operation of the gas turbine engine.

Additionally or alternatively, in this or other embodiments a flow regulating device is configured to selectably control the flow of fuel from the main fuel pump and the secondary fuel pump.

Additionally or alternatively, in this or other embodiments operation of the main fuel pump is stopped when operation of the secondary fuel pump is started.

Additionally or alternatively, in this or other embodiments the main fuel pump is mechanically driven via a gearbox of the gas turbine engine.

In another exemplary embodiment, a gas turbine engine and fuel delivery system includes a gas turbine engine having a turbine and a combustor where fuel is combusted to drive the turbine via a flow of combustion products. A fuel delivery system is operably connected to the gas turbine engine and includes a fuel source and a main fuel pump configured to deliver a first flow of fuel to the combustor under a first, relatively high fuel demand operating condition of the gas turbine engine. A secondary fuel pump is configured to deliver a second flow of fuel to the combustor under a second, relatively low fuel demand operating condition of the gas turbine engine.

Additionally or alternatively, in this or other embodiments the secondary fuel pump is electrically driven.

Additionally or alternatively, in this or other embodiments the first operating condition is takeoff operation of the gas turbine engine.

Additionally or alternatively, in this or other embodiments the second operating condition is cruise operation of the gas turbine engine.

Additionally or alternatively, in this or other embodiments a flow regulating device is configured to selectably control the flow of fuel from the main fuel pump and the secondary fuel pump.

Additionally or alternatively, in this or other embodiments operation of the main fuel pump is stopped when operation of the secondary fuel pump is started.

Additionally or alternatively, in this or other embodiments the main fuel pump is mechanically driven via a gearbox of the gas turbine engine.

In yet another exemplary embodiment, a method of operating a gas turbine engine and fuel delivery system includes operating a gas turbine engine at a first, relatively high fuel demand operating condition, delivering a first flow of fuel to a combustor of the gas turbine engine via a main fuel pump, switching operation of the gas turbine engine to a second, relatively low fuel demand operating condition, and starting operation of a secondary fuel pump to deliver a second flow of fuel to the combustor.

Additionally or alternatively, in this or other embodiments operation of the main fuel pump is stopped when operation of the secondary fuel pump is started.

Additionally or alternatively, in this or other embodiments the secondary fuel pump is electrically driven.

Additionally or alternatively, in this or other embodiments the first operating condition is takeoff operation of the gas turbine engine.

Additionally or alternatively, in this or other embodiments the second operating condition is cruise operation of the gas turbine engine.

Additionally or alternatively, in this or other embodiments the main fuel pump is mechanically driven via a gearbox of the gas turbine engine.

### BRIEF DESCRIPTION OF THE DRAWINGS

The following descriptions should not be considered limiting in any way. With reference to the accompanying drawings, like elements are numbered alike:

FIG. 1 is a schematic illustration of an embodiment of a gas turbine engine and fuel delivery system through which fuel is delivered to power the gas turbine engine; and

FIG. 2 is a schematic illustration of an embodiment of a fuel delivery system of a gas turbine engine.

### DETAILED DESCRIPTION

A detailed description of one or more embodiments of the disclosed apparatus and method are presented herein by way of exemplification and not limitation with reference to the Figures.

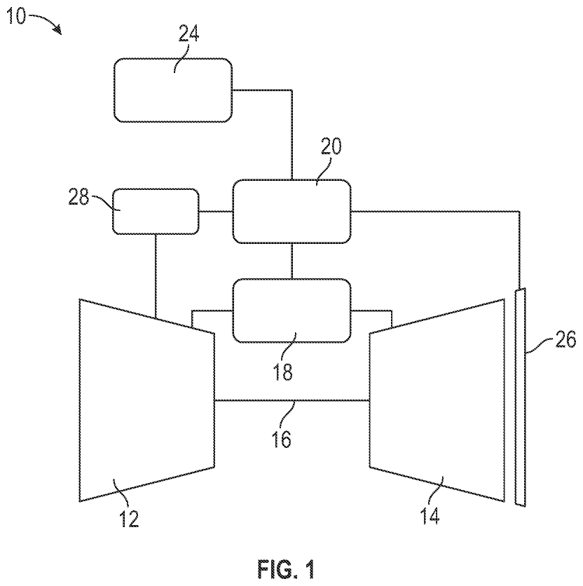

An aircraft gas turbine engine system is indicated generally at 10 in FIG. 1. Gas turbine engine system 10 includes a compressor portion 12 operatively coupled to a turbine portion 14 through a shaft 16. A combustor assembly 18 is fluidically connected between the compressor portion 12 and turbine portion 14. A fuel delivery system 20 fluidically connects the combustor assembly 14 with a source of fuel 24. Fuel delivery system 20 may receive fuel directly from source of fuel 24 or, through a compressor stage (not shown) that creates an input pressure for the fuel. In addition to the combustor assembly 18, the fuel delivery system 20 may be operably connected to one or more secondary components, such as an augmentor 26 to deliver a flow of fuel thereto. In some embodiments, a gearbox 28 is operably connected to the gas turbine engine 10 via, for example, the shaft 16 to extract power from the gas turbine engine 10. The fuel delivery system 20 is operably coupled to the gearbox to power components of the fuel delivery system 20.

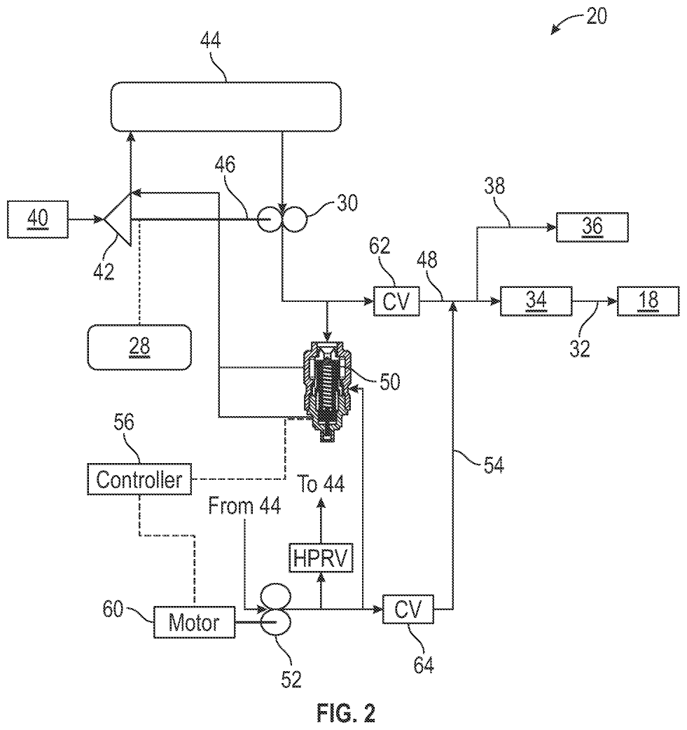

Referring now to FIG. 2, the fuel delivery system 20 will now be described in greater detail. The fuel delivery system 20 includes a main pump 30 that directs fuel to the combustor assembly 18 via a combustor fuel line 32, with a combustor fuel control 34 located along the combustor fuel line 32 to control the flow of fuel to the combustor assembly 18. Additionally, in some embodiments the main pump 30 further directs fuel toward one or more actuation devices 36 via an actuation fuel line 38 to drive operation of the actuation devices 36.

Fuel is introduced to the fuel delivery system 20 from a fuel source 40, such as a fuel tank or the like. The fuel may be initially directed through a boost pump 42 before passing through one or more interstage components 44 located between the boost pump 42 and the main pump 30. In some embodiments, the interstage components 44 may include one or more fuel filters or fuel valves. Both the main pump 30 and the boost pump 42 are operably connected to the gearbox 28 and are mechanically driven by a pump shaft 46 connected to the gearbox 28.

From the interstage components 44, the fuel is directed through the main pump 30 and to the combustor assembly 18 along a main fuel pathway 48. A pressure regulating device 50 is fluidly connected to the main pump 30, and in some embodiments is a combination high pressure relief valve (HPRV) and windmill bypass valve (WMBV). This combination HPRV/WMBV 50 is also fluidly connected to an electrically-driven secondary fuel pump 52. In some embodiments, the secondary fuel pump 52 is a variable speed pump. The secondary fuel pump 52 selectably directs fuel to the combustor assembly 18 along a secondary fuel pathway 54.

A fuel system controller 56 is operably connected to the HPRV/WMBV 50 and to the secondary fuel pump 52. At relatively high demand operating conditions, such as aircraft takeoff, fuel demand of the gas turbine engine 10 is high, so the fuel delivery system 20 utilizes the main pump 30 to deliver fuel to the combustor assembly 18. The HPRV/WMBV 50 is in a HPRV position to protect the fuel delivery system 20 in the event of an over pressurization event resulting from operation of the main pump 30. When the gas turbine engine 10 transitions to a relatively low fuel demand operating conditions, such as cruise operation, the fuel system controller 56 activates the secondary fuel pump 52 by, for example, powering an electric motor 60 to drive the secondary fuel pump 52. The secondary fuel pump 52 urges fuel along the secondary fuel pathway 54 toward the combustor assembly 18. The resulting pressure of the fuel flow when the secondary fuel pump 52 is activated causes a change in a cracking pressure of the main pump 30, causing the main pump 30 to stop operation. The HPRV/WMBV 50 is switched to WMBV mode to reduce a pressure rise or horsepower demand on the main pump 30. When the operating mode of the gas turbine engine 10 and the fuel delivery system 20 is switched back to a relatively high demand condition, the secondary fuel pump 52 may be deenergized by the fuel system controller 56, thus restarting operation of the main pump 30.

Additionally, the fuel delivery system 20 includes a primary check valve 62 located along the main fuel pathway 48 downstream of the main pump 30 to prevent fuel from the secondary fuel pathway 54 from flowing toward the main pump 30 and/or fuel from the combustor assembly 18 from flowing toward the main pump 30. Similarly, a secondary check valve 64 is located along the secondary fuel pathway 54 to prevent fuel from the main fuel pathway 48 and/or from the combustor assembly 18 from flowing toward the secondary fuel pump 52.

While the main pump 30 is sized to cover all operating conditions of the gas turbine engine 10 and the fuel delivery system 20, it is optimally operated at the takeoff operating condition. The secondary fuel pump 52 may be sized and configured for operation at a selected operating point or range of points, such as cruise operation. This allows for efficient delivery of fuel via the secondary fuel pump 52 during cruise operation, rather than utilizing the main pump 30 at this operating condition, which may be less efficient. Since the secondary fuel pump 52 is electrically operated and configured for operation during the relatively low demand cruise condition, it may be a small and lightweight pump. At other points, electric pump stopped and main pump reenergized.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A fuel delivery system for a gas turbine engine, comprising:
a fuel source;
a main fuel pump configured to deliver a first flow of fuel to a combustor assembly of the gas turbine engine under a first operating condition of the gas turbine engine;
a secondary fuel pump configured to deliver a second flow of fuel to the combustor assembly under a second operating condition of the gas turbine engine, the first operating condition having a higher fuel demand than the second operating condition; and
a combination high pressure relief valve (HPRV) and windmill bypass valve (WMBV) operably connected to both the main fuel pump and the secondary fuel pump, the combination HPRV/WMBV configured to operate in HPRV mode in the first operating condition to prevent overpressurization from operation of the main fuel pump, and configured to operate in WMBV mode in the second operating condition to reduce a pressure rise on the main fuel pump;
wherein the fuel delivery system is configured such that operation of the secondary fuel pump is stopped when operation of the main fuel pump is started.

2. The fuel delivery system of claim 1, wherein the secondary fuel pump is electrically driven.

3. The fuel delivery system of claim 1, wherein the first operating condition is takeoff operation of the gas turbine engine.

4. The fuel delivery system of claim 1, wherein the second operating condition is cruise operation of the gas turbine engine.

5. (canceled)

6. The fuel delivery system of claim 1, wherein operation of the main fuel pump is stopped when operation of the secondary fuel pump is started.

7. The fuel delivery system of claim 1, wherein the main fuel pump is mechanically driven via a gearbox of the gas turbine engine.

8. A gas turbine engine and fuel delivery system, comprising:
a gas turbine engine, including:
a turbine; and
a combustor where fuel is combusted to drive the turbine via a flow of combustion products; and
a fuel delivery system operably connected to the gas turbine engine, including:
a fuel source;
a main fuel pump configured to deliver a first flow of fuel to the combustor under a first operating condition of the gas turbine engine; and
a secondary fuel pump configured to deliver a second flow of fuel to the combustor under a second operating condition of the gas turbine engine, the first operating condition having a higher fuel demand than the second operating condition; and
a combination high pressure relief valve (HPRV) and windmill bypass valve (WMBV) operably connected to both the main fuel pump and the secondary fuel pump, the combination HPRV/WMBV configured to operate in HPRV mode in the first operating condition to prevent overpressurization from operation of the main fuel pump, and configured to operate in WMBV mode in the second operating condition to reduce a pressure rise on the main fuel pump;
wherein the fuel delivery system is configured such that operation of the secondary fuel pump is stopped when operation of the main fuel pump is started.

9. The gas turbine engine and fuel delivery system of claim 8, wherein the secondary fuel pump is electrically driven.

10. The gas turbine engine and fuel delivery system of claim 8, wherein the first operating condition is takeoff operation of the gas turbine engine.

11. The gas turbine engine and fuel delivery system of claim 8, wherein the second operating condition is cruise operation of the gas turbine engine.

12. (canceled)

13. The gas turbine engine and fuel delivery system of claim 8, wherein operation of the main fuel pump is stopped when operation of the secondary fuel pump is started.

14. The gas turbine engine and fuel delivery system of claim 8, wherein the main fuel pump is mechanically driven via a gearbox of the gas turbine engine.

15. A method of operating a gas turbine engine and fuel delivery system, comprising:
operating a gas turbine engine at a first operating condition;
delivering a first flow of fuel to a combustor of the gas turbine engine via a main fuel pump;
switching operation of the gas turbine engine to a second operating condition; and
starting operation of a secondary fuel pump to deliver a second flow of fuel to the combustor; and
operating a combination high pressure relief valve (HPRV) and windmill bypass valve (WMBV) operably connected to both the main fuel pump and the secondary fuel pump, the combination HPRV/WMBV operating in HPRV mode in the first operating condition to prevent overpressurization from operation of the main fuel pump, and operating in WMBV mode in the second operating condition to reduce a pressure rise on the main fuel pump;
wherein the first operating condition has a higher fuel demand than the second operating condition;
wherein operation of the secondary fuel pump is stopped when operation of the main fuel pump is started.

16. The method of claim 15, further comprising stopping operation of the main fuel pump when operation of the secondary fuel pump is started.

17. The method of claim 15, wherein the secondary fuel pump is electrically driven.

18. The method of claim 15, wherein the first operating condition is takeoff operation of the gas turbine engine.

19. The method of claim 15, wherein the second operating condition is cruise operation of the gas turbine engine.

20. The method of claim 15, wherein the main fuel pump is mechanically driven via a gearbox of the gas turbine engine.
